(19) United States
(12) Patent Application Publication
(10) Pub. No.: US 2012/0217304 A1
(43) Pub. Date: Aug. 30, 2012

(54) SYSTEM AND METHOD FOR AUTHORIZING A RIGHT OR BENEFIT

(75) Inventor: Paul D. Atkinson, Poway, CA (US)

(73) Assignee: MYPLACE, INC., La Jolla, CA (US)

(21) Appl. No.: 13/405,227

(22) Filed: Feb. 24, 2012

Related U.S. Application Data
(60) Provisional application No. 61/446,390, filed on Feb. 24, 2011.
(60) Provisional application No. 61/484,995, filed on May 11, 2011.
(60) Provisional application No. 61/500,185, filed on Jun. 23, 2011.

(51) Int. Cl. G06K 19/02; G06K 19/06; G06K 19/00

(52) U.S. Cl. 235/488; 235/487; 235/494

(57) ABSTRACT

Systems and methods for securing access to benefits included with various products for sale are disclosed herein. At least two code identifiers may be included upon a substrate to be inserted or affixed to a product, or alternatively, upon a surface or material of the product or its packaging. The respective code identifiers together form a unique code which maps to a set of rights or benefits intended to be conferred upon a consumer. The code identifiers may be duplex printed upon the substrate or product material in order to curb or eliminate matching errors. In some embodiments, the substrate or product material may be selected, configured, or assembled so as to readily evidence product tampering. Various embodiments of the present invention advantageously enable product localization without the collection of personal information from the consumer, while simultaneously curbing illicit access from unauthorized parties.

### RELATED APPLICATIONS

This application claims the benefit of U.S. Provisional Application Ser. No. 61/446,390, filed Feb. 24, 2011, U.S. Provisional Application Ser. No. 61/484,995, filed May 11, 2011, and U.S. Provisional Application Ser. No. 61/500,185, filed Jun. 23, 2011, the contents of which are incorporated herein by reference in their entireties as if set forth in full.

### BACKGROUND

1. Field of the Invention

The embodiments described herein relate generally to the field of secured access technologies, and more particularly, to systems and methods for securing access to rights or benefits included with the sale of a product.

2. Related Art

In the retail industry it is often desirable to provide a benefit to a customer that is dependent on a particular item being sold. In some cases, the benefit may be a “right” to access media content over a network (e.g., a downloadable copy of a motion picture), where such a right is authorized only after the product has been sold. In other cases, the benefit may simply refer to some feature, advantage, or provision associated with either the actual product for sale, the manufacturer or retailer selling the product, or a particular geographic region where the product is being sold (for example, warranties, return policies, promotional or exclusive offers, complementary goods, repair or maintenance policies, off-site merchandise, etc.).

With existing solutions, however, there is often a risk that the benefit/right may be claimed or accessed by someone other than the original purchaser due to illicit acquisition of the access code contained within the product being sold or within its packaging. In many instances, merchandise within the store may be opened and the access code recorded or photographed. This activity often remains undetected as the merchandise may be subsequently reassembled, appearing as if its contents have not been uncompromised.

Certain conventional techniques utilize a code comprising a human readable text string, machine readable code, or a symbology (such as a bar code or Quick Response code) that remains hidden while the item is sold. For example, some codes may be concealed within areas intended to be scratched off or otherwise peeled away. In other cases, the code may be printed on the inside of the merchandise and are accessible only after the product or product packaging has been opened (e.g., a code printed on the inside of a bottle cap 900.) To varying degrees, each of these methods relies on the consumer or merchant properly identifying and rejecting any merchandise appearing to have been compromised or potentially accessed by an unauthorized party prior to the item being purchased (e.g., as when a bottle cap 900 appears to have been already removed from the bottle, or when the scratch layer of a gift card appears to have been tampered with). However, the access codes of many such products are compromised and replaced on store shelves. Absent evidence of tampering, an unsuspecting purchaser may wind up purchasing the item, only discovering later that the access code has already been used and is thus no longer valid.

Another drawback of utilizing only a single, unique “hidden” code is that such systems do not enable the tracking of individual items sold at particular retailers. A stock-keeping unit (SKU) code may be affixed the merchandise, but such a code only describes the category of item being sold, as opposed to any individual unit contained within that category. This prevents manufacturers, distributors, and retailers from attaching certain benefits/rights only to items sold at particular stores or within particular geographic regions.

Additionally, without authorization of particular items at the point-of-sale location, there is an increased risk that an unauthorized party will utilize a script or other program to test a large number codes in order to identify a subset of authorized codes. In addition, if a specific mathematical function has been used to generate each code, key generators may be derived and distributed all across the Internet, potentially enabling hundreds of thousands of unauthorized individuals to access the included benefit.

Some conventional techniques utilize only a point-of-sale code (such as a human readable text string, machine readable code, bar code, or a Quick Response code). However, this technique also presents various complications. In cases where the product may only be activated at the point-of-sale, this requires that the store maintain a continually active network connection. Otherwise, the consumer is forced wait for some period for a delayed activation. In other cases, the access code must remain visible to the line-of-sight of a bar-code scanner. With the code being visible on the product packaging itself, illicit acquisition of the code becomes a very real concern.

Radio Frequency Identification (RFID) tags are another means of attempting to securely provide the information, but these tags are relatively expensive compared to optical codes. These devices are also costly to embed within products, and require either that consumers have RFID readers with which to read the “hidden code” after the item has been purchased, or otherwise require significant infrastructure upgrades throughout the supply chain.

What is needed is a tamper-evident system of securing access to rights or benefits that are included with the purchase of a product. Ideally, the system will be less expensive than RFID technology, and yet less susceptible to fraud or exploitation than conventional hidden code or point-of-sale systems (or a combination thereof). Additionally, the system should also enable manufacturers, distributors, and retailers to attach localized benefits/rights to individual items of a single category of products that are being sold at different dates/times, at different stores, or within different geographic locations.

### SUMMARY

Various embodiments of the present invention are directed to systems and methods for securing access to benefits included with various products for sale. At least two code identifiers may be included upon a substrate to be inserted or affixed to a product, or alternatively, upon a surface or material of the product or its packaging. The respective code identifiers together form a unique code which maps to a set of rights or benefits intended to be conferred upon a consumer. The code identifiers may be duplex printed upon the substrate or product material in order to curb or eliminate matching errors. In some embodiments, the substrate or product material may be selected, configured, or assembled so as to readily evidence product tampering. Various embodiments of the present invention advantageously enable product localization without the collection of personal information from the consumer, while simultaneously curbing illicit access from unauthorized parties to the set of rights or benefits that are included with the sale of the product.

In a first exemplary aspect, a substrate is disclosed. The substrate contains identifiers used for securing access to a benefit included with the sale of a product. In one embodiment, the substrate comprises a first identifier disposed upon a first surface of the substrate; and a second identifier disposed upon a second surface of the substrate, the first and second identifiers being duplex printed on the substrate and configured to form a unique identifier which maps to a set of one or more rules at a remote computing device; wherein the substrate is configured to be disposed within a container associated with the product such that the second identifier is visible only when the container has been opened.

In a second exemplary aspect, a material is disclosed. The material bears identifiers used for securing access to a benefit included with the sale of a product. In one embodiment, the material comprises a first identifier disposed upon a first surface of the material; and a second identifier disposed upon a second surface of the material, the first and second identifiers being duplex printed on the material and configured to form a unique identifier which maps to a set of one or more rules at a remote computing device; wherein the material is configured to form at least a portion of the product and is positioned such that the second identifier is visible only when the product has been opened.

Other features and advantages of the present invention should become apparent from the following description of the preferred embodiments, taken in conjunction with the accompanying drawings, which illustrate, by way of example, the principles of the invention.

### BRIEF DESCRIPTION OF THE DRAWINGS

Various embodiments disclosed herein are described in detail with reference to the following figures. The drawings are provided for purposes of illustration only and merely depict typical or exemplary embodiments. These drawings are provided to facilitate the reader's understanding of the invention and shall not be considered limiting of the breadth, scope, or applicability of the embodiments. It should be noted that for clarity and ease of illustration these drawings are not necessarily made to scale.

FIG. 1 is a block diagram illustrating an exemplary network configuration which may be used to trigger a set of one or more rules which map to a unique code according to one embodiment of the present invention.

FIG. 2 is a block diagram illustrating an exemplary authentication node according to one embodiment of the present invention.

FIG. 3 is a flow diagram illustrating an exemplary method of authentication according to one embodiment of the present invention.

FIG. 4a is a screen capture of the rear and front of exemplary insert bearing a visible first unique identifier and a hidden second unique identifier in accordance with one embodiment of the present invention.

FIG. 4b is a screen capture of the top and bottom of the exemplary insert depicted in FIG. 4a.

FIG. 5a is a screen capture of the rear and front of exemplary Blu-ray case bearing a visible first unique identifier and a hidden second unique identifier in accordance with one embodiment of the present invention.

FIG. 5b is a screen capture of the top and bottom of the exemplary Blu-ray case depicted in FIG. 5a.

FIG. 6a is a screen capture of the top and bottom of an exemplary Blu-ray case containing an insert with a second unique identifier hidden by a Blu-ray disc in accordance with one embodiment of the present invention.

FIG. 6b is a screen capture of the top and bottom of an exemplary Blu-ray case showing the second unique identifier exposed when the Blu-ray disc is removed in accordance with the embodiment depicted in FIG. 6a.

FIG. 7a is a screen capture of the top and bottom of an exemplary DVD case containing an insert with a second unique identifier visible through cut-outs in the case in accordance with one embodiment of the present invention.

FIG. 7b is a screen capture of the top and bottom of the exemplary DVD case where the second unique identifier is hidden by a DVD in accordance with the embodiment depicted in FIG. 7a.

FIG. 8 is a flow diagram illustrating a high-level method of utilizing a system of controlling access to secure media content in accordance with one embodiment of the present invention.

FIG. 9a is a block diagram illustrating the top of exemplary bottle cap bearing a first and second code according to one embodiment of the present invention.

FIG. 9b is a block diagram illustrating the underside of the bottle cap depicted in FIG. 9a.

FIG. 10 is a block diagram illustrating a soda bottle containing a label bearing an exemplary third code according to one embodiment of the present invention.

FIG. 11 is a sketch of an exemplary soda bottle case bearing a third code according to one embodiment of the present invention.

FIG. 12 is a sketch of an exemplary oatmeal case bearing a third code according to one embodiment of the present invention.

FIG. 13 is a flow diagram of an exemplary process of packaging codes as may be utilized by a manufacturer according to one embodiment of the present invention.

FIG. 14 is a flow diagram of an exemplary process of processing codes as may be utilized by a retailer according to one embodiment of the present invention.

These drawings are more readily comprehendible with reference to the following detailed description presented below.

### DETAILED DESCRIPTION

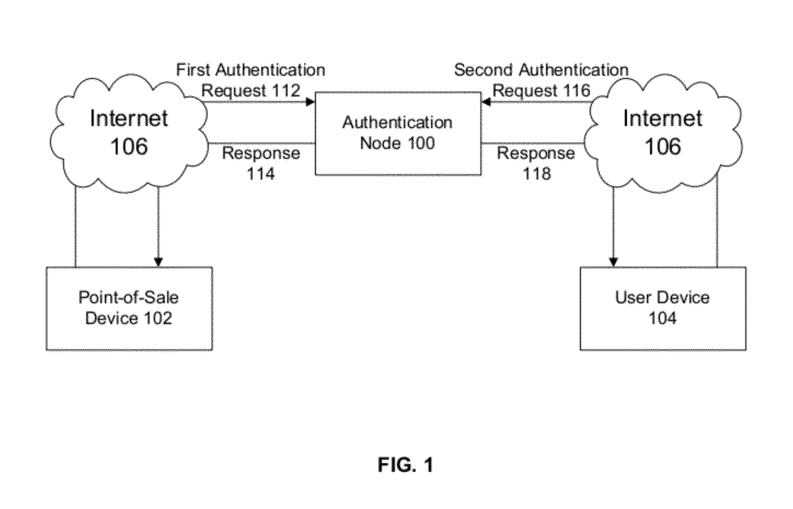

FIG. 1 is a block diagram illustrating an exemplary network configuration which may be used to trigger a set of one or more rules which map to a unique code according to one embodiment of the present invention. In some embodiments, the rules may enable content to be unlocked within a digital medium or downloaded/streamed over a connected network. In other embodiments, the rules may trigger the delivery or provision of one or more benefits that have been included with the purchase of a product (for example, warranties, return policies, promotional or exclusive offers, complementary goods, repair or maintenance policies, off-site merchandise for delivery, etc.).

It should be noted at the outset that various embodiments of the present invention advantageously allow for the delivery or provision of one or more rights or benefits to the consumer, yet without necessarily requiring the consumer to submit personal, private, or confidential information in order to receive such a right or benefit. At the same time, various embodiments may also allow for product localization. That is to say, a manufacturer, distributor, or retailer can assign different sets of benefits to different groupings of the same model or type of product currently being offered for sale. For example, a high-definition LCD television sold in Cincinnati may include a delivery package offering discounts to local retail chain selling Bengal memorabilia, or alternatively, the purchase may enable the consumer to access downloadable content related to the Cincinnati Bengals. If the same television was sold in San Diego, the package may instead include discounts to Charger memorabilia or downloadable content related to the San Diego Chargers.

Note also that benefits may also be assigned based on vendor, rather than (or in addition to) being predicated upon the geographic area. For example, the television sold at Best Buy may include a benefit that would not otherwise be included if the same television were purchased at a different retailer.

As illustrated by FIG. 1, a point-of-sale device 102 and a user device 104 are connected to an authentication node 100 by a network connection, such as the Internet 106. It should be noted here that for the purposes of FIG. 1, and with respect to subsequent figures, the “authentication” of a constituent portion of an access code is best conceived of as something separate from that triggering a rule which would allow for the delivery or provision of one or more benefits/rights that are included with a product for sale (which might also be conceived as a form of “authentication”). Authentication of a constituent portion of an access code may require searching through a data structure (such as a database, file, array, list, queue, stack, tree, hashtable, heap, etc.) in order to identify that respective portion of the code. According to various embodiments, the set of rules may be triggered, for example, only when each constituent portion of a unique identifier has each been successfully authenticated.

When an item is purchased, a code reader (not shown) in electrical communication with the point-of-sale device 102 may first read a first code identifier that is externally visible on the packaging (or alternatively, upon an external surface of the purchased item itself). In some embodiments, this code may instead be a human readable code that is manually input into an I/O peripheral (e.g., a keyboard, mouse, touch panel, or microphone) associated with the point-of-sale device 102.

The authentication node 100 then receives a first authentication request 112 from the point-of-sale device 102. The point-of-sale device 102 may be a device associated with an authorized first party with the means to read and transmit the first code identifier to a key registry disposed within the authentication node 100 (for example, as read by a countertop bar code reader interfaced with a system having access to the Internet 106). A response 114 may then be generated and transmitted back to the point-of-sale device 102. This response 114 serves to indicate whether authentication of the first code identifier was successful or unsuccessful. Optionally, an acknowledgement number or receipt may then be provided to the user/purchaser which serves as evidence that the authentication of the first code had been performed successfully.

A second code identifier is also included with the purchased item. In some embodiments, this second code identifier is visible to the user only when the package has been opened (e.g., unfolded or had its shrink-wrap punctured or removed). This second code may be a human readable code that is manually input into a user device 104 and subsequently transmitted to the authentication node 100 via the Internet 106 (e.g., a string of characters to be input into a personal computer with an internet connection). In other embodiments, the code may be a machine readable code requiring an associated scanner, imager, or other such reading device (e.g., a mobile phone with a quick-response (QR) code capable application).

In some embodiments, the combination of the first code identifier and the second code identifier forms a combination of identifiers which may uniquely map to a set of one or more rights or benefits. The first code identifier and/or the second code identifier may themselves be unique in addition to the identifier combination. In some embodiments, the first code identifier and the second code identifier may each be generated randomly (or pseudo-randomly) in order to prevent a functional relationship between the identifiers from being established by an outside party. Also, according to some embodiments, a newly generated first code identifier may be tested against a listing of previously generated first code identifiers and discarded in the event that the same code identifier already exists.

Returning again to FIG. 1, a second authentication request 116 may then be generated at the user device 104 and subsequently transmitted to the authentication node 100. In some embodiments, the authentication node 100 may transmit a response 118 to the user device 104 indicating whether the second code identifier had been successfully authenticated. Once both the first code identifier and the second code identifier have been successfully authenticated, the rule may then be triggered so as to confer the right or benefit included with the product for sale. For example, in some embodiments, one or more functions associated with the media content may then be unlocked (e.g., an option to playback an inserted Blu-ray disc or DVD may then be presented, or an option to download or stream the media content to the user device 104).

While the point-of-sale device 102 and the user device 104 are depicted in FIG. 1 as being connected to the authentication node 100 via a connection to the Internet 106, it is to be understood that any type of networking medium and/or networking protocol may be used in the alternative (e.g., cellular networks, fiber-optic networks, cable networks, satellite networks, wireless networks, serial bus networks, etc.), and further, that the network connection between the point-of-sale device 102 and the authentication node 100 may be a different type of network connection than that between the user device 102 and the authentication node 100. Additionally, any type of network configuration or network topology may be used in accordance with the scope of various embodiments (e.g., personal area networks, metropolitan area networks, wide area networks, direct connection networks, star networks, ring topologies, etc.).

Additionally, the point-of-sale device 102 and the user device 104 may consist of any type of electronic or computing device. For example, the user device 104 may include, without limitation, a personal computer, a smart phone, a gaming console, a Blu-ray player, a streaming device capable of receiving movies, a personal data assistant, an e-reader, or a cable set-top box.

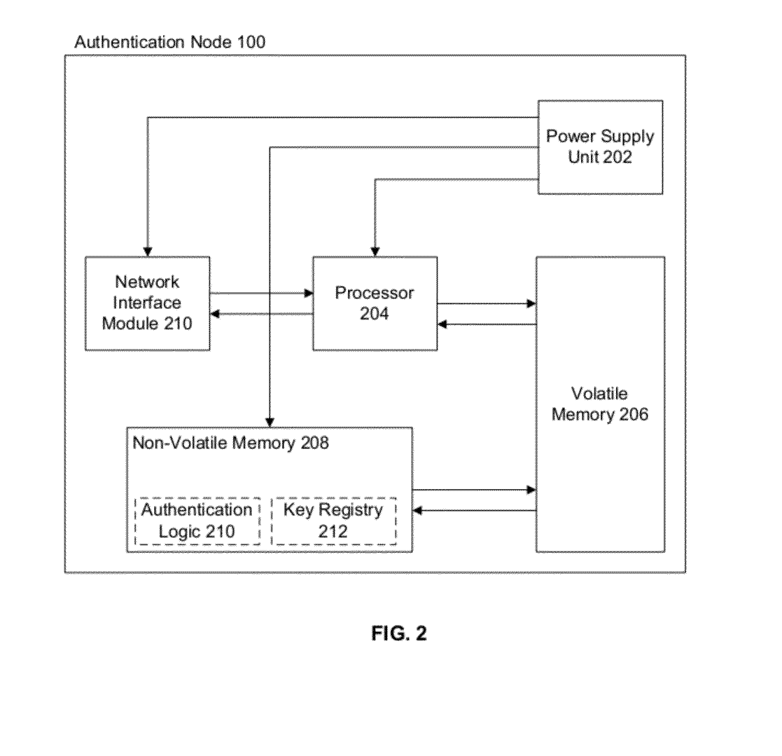

FIG. 2 is a block diagram of an exemplary authentication node 100 according to one embodiment of the present invention. As illustrated by FIG. 2, authentication node 100 may include a power supply 202, one or more processors 204, volatile memory 206, non-volatile memory 208, and a network interface module 210. Non-volatile memory may further include authentication logic 210 and key registry 212.

A power supply unit 202 may provide a source of power to the various modules disposed within the authentication node 100. In some embodiments, power may be supplied externally by one or more conductive wires, for example, from a power cable or serial bus cable. In other embodiments, a battery may be used as a source of power.

One or more processors 204 are adapted to execute sequences of instructions by loading and storing data to memory. Possible instructions include, without limitation, instructions for data conversion, formatting operations, communication instructions, and/or storage and retrieval operations. Additionally, the one or more processors 204 may comprise any type of digital processing devices including, for example, reduced instruction set computer processors, general-purpose processors, microprocessors, digital signal processors, gate arrays, programmable logic devices, reconfigurable compute fabrics, array processors, and/or application-specific integrated circuits. Note also that the one or more processors 204 may be contained on a single unitary integrated circuit die or distributed across multiple components.

Authentication node 100 also comprises any combination of volatile 206 and non-volatile memory 208 adapted to enable digital information to be stored, retained, and subsequently retrieved. This includes RAM, DRAM, SRAM, ROM, and/or flash memory. These memory modules 206 and 208 may be organized in any number of architectural configurations utilizing, for example, registers, memory cashes, data buffers, main memory, mass storage and/or removable media. In some embodiments, the non-volatile memory 208 comprises authentication logic 210 and optionally, a key registry 212. Both of these modules may be used for unlocking access to media content secured over a network. During operation, pages of memory may be swapped out of non-volatile memory 208 and into volatile memory 206 in order to enable the one or more processors 204 to have quicker access to requested data.

The authentication logic 210 could be any combination of software, firmware, or hardware that enables authentication of constituent portions of a unique code identifier. The authentication logic 210 may include a mapping of a set of rules to each unique identifier, whereby successful authentication of each constituent portion of a unique code identifier triggers the set of rules. A means for generating unique codes and for associating such codes with a respective set of rules may also be included within the authentication logic 210, or may be provided within a separate module according to some embodiments.

Key registry 212 may be any data structure (e.g., database, file, array, list, queue, stack, tree, hashtable, heap, etc.) that generates, associates, and stores constituent portions of each unique code. The constituent portions of the code may be stored within separate data structures in the alternative.

In some embodiments, the key registry 212 may be used to provide the constituent portions to a peripheral device for printing or otherwise affixing onto inserts. Duplex printing may then be used to simultaneously (or near-simultaneously) print a first code and its paired second code on opposite sides of the same substrate or material. Linking the codes together in this fashion advantageously mitigates errors caused by inadvertent insertion of mispaired codes within the same product casing.

In some embodiments, the key registry 212 itself may contain the listing of rights associated with each code in the registry 212. More than one right may be associated with each code. For example, a DVD bundle may be sold with rights to download all three movies in particular trilogy. Alternatively, a special edition video game may feature additional content bundled with the game to be downloaded, where a single code is used to unlock access to both the downloadable game as well as the additional content.

Authentication node 100 may also have one or more network interface modules 210 for interfacing over networks associated with the point-of-sale device 102 and the user device 104 (as seen in FIG. 1). As stated above, any type of network may be used for these purposes, including, without limitation cellular networks, fiber-optic networks, cable networks, satellite networks, wireless networks, serial bus networks, etc.

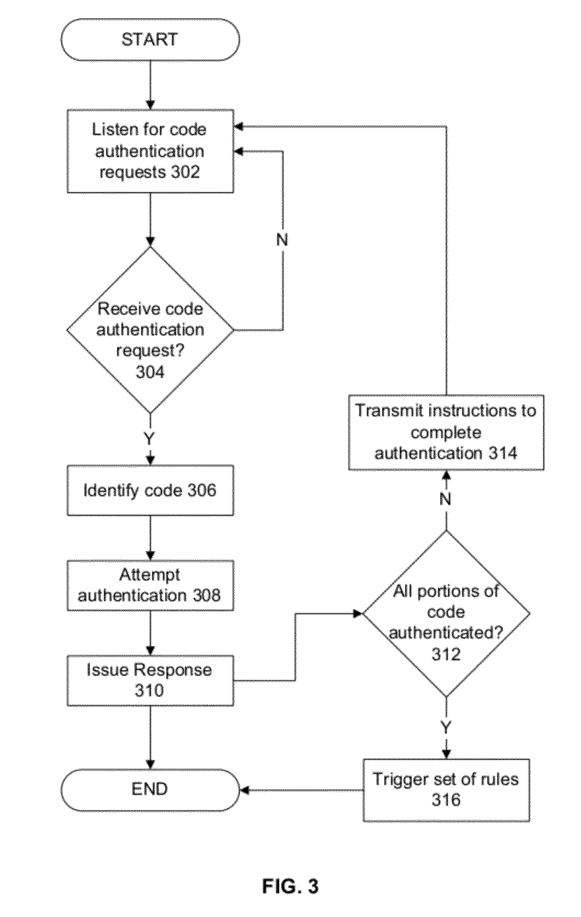

FIG. 3 is a flow diagram of an exemplary method of authentication according to one embodiment of the present invention. In some embodiments, the depicted method may be performed, for example, by the authentication node 100 depicted in FIG. 1 and FIG. 2.

At block 302, the system listens for code authentication requests submitted from either a point-of-sale device 102 or a user device 102. A transmission triggering an event or interrupt may be used for this purpose. In other embodiments, the authentication node 100 may periodically poll the point-of-sale device 102 and/or the user device 104.

If a code authentication request is received (for example, as shown in decision block 304), the constituent portion of the code is then analyzed at block 306. In some embodiments, a flag or other indicator may be submitted with the code authentication requests indicating that this portion of the code is associated with either a point-of-sale device 102 or a user device 102 (or alternatively, that the enclosed code portion represents the first half or second half of the entire code sequence). An error message may be generated if the code portion cannot be properly identified.

Once the code portion has been successfully identified, then authentication of the code portion is attempted at block 308. This process may involve comparing the transmitted code with a particular sequence contained within a key registry 212 (see, e.g., FIG. 2). If authentication is successful, a flag or variable may be updated so as to indicate that this respective portion of the unique code has been successfully validated.

A response may then be generated at block 310 indicating whether a match (i.e., identification of the constituent portion of the unique code) had been successful. In some embodiments, a network security module may be employed in order to limit the number of authentication attempts generated from a certain domain or IP address.

In some embodiments, rules associated with particular identifiers govern the authorization and fulfillment of the benefit/right conferred upon successful authentication. For example, in one embodiment, the rules may authorize access to the content when at least two conditions are met. First, when the key registry 212 receives a first unique identifier from an authorized first party (which is typically a vendor/retailer), and second, when the key registry receives a second unique identifier from a second party (which is typically a consumer) after the key registry 212 has been received from the first party.

Returning again to FIG. 3, at block 312, a test may be performed in order to determine whether all portions of the unique code have been successfully authenticated. In embodiments containing two or more separate constituent portions of the code, this may involve checking a series of variables, a list, or an array for the purposes of determining whether all such portions have been successfully authenticated. A Boolean or binary value may be set in the event that all portions of the code have been successfully authenticated.

If the each portion of the unique code has still not been authenticated, then at block 314, a set of instructions may be transmitted to the device issuing the code authentication request. The authentication node 100 may then resume listening for code authentication requests at block 302.

Conversely, if each portion of the unique code has been successfully authenticated, the corresponding set of rules may then be triggered at block 316. In one embodiment, this may involve transmitting an unlock sequence or key to the user device 104. The user may then input this sequence or key into a program interface in order to access the requested media. In other embodiments, a file may be uploaded to the user device 104 which overwrites or adds an additional file to the user device 104, the presence of which enables access to the requested media. In still other embodiments, authentication node 100 may initiate a transfer of the requested content from one of its own memory modules, or otherwise provide a special instruction to a remote content server (not shown) for initiating a transfer of the requested content to the user device 104. The process then ends.

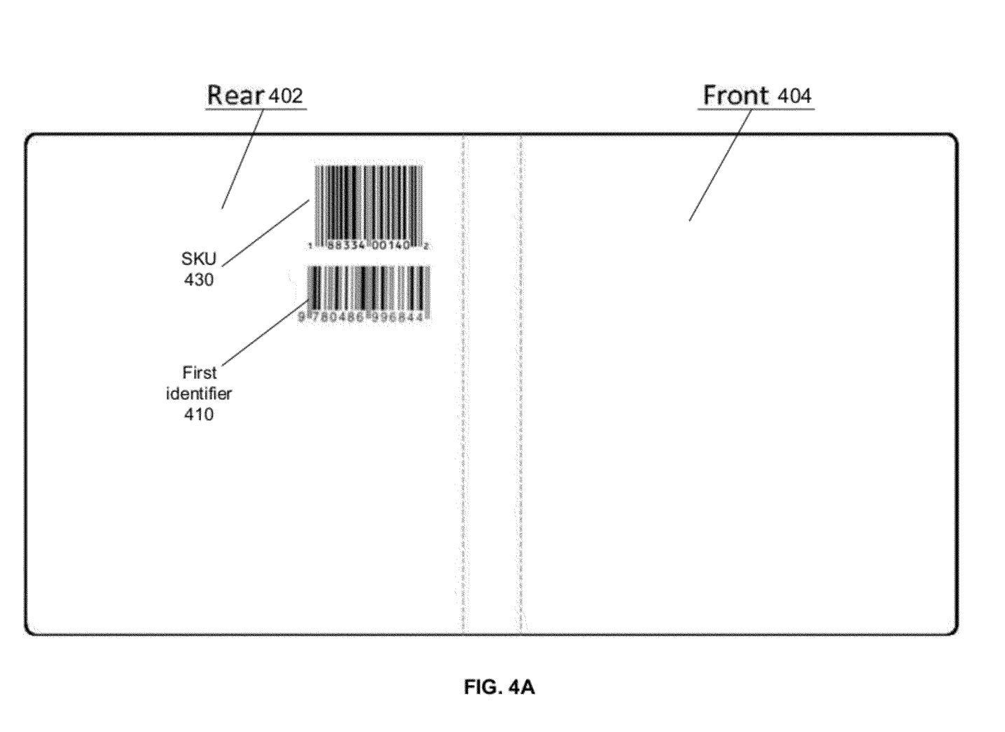

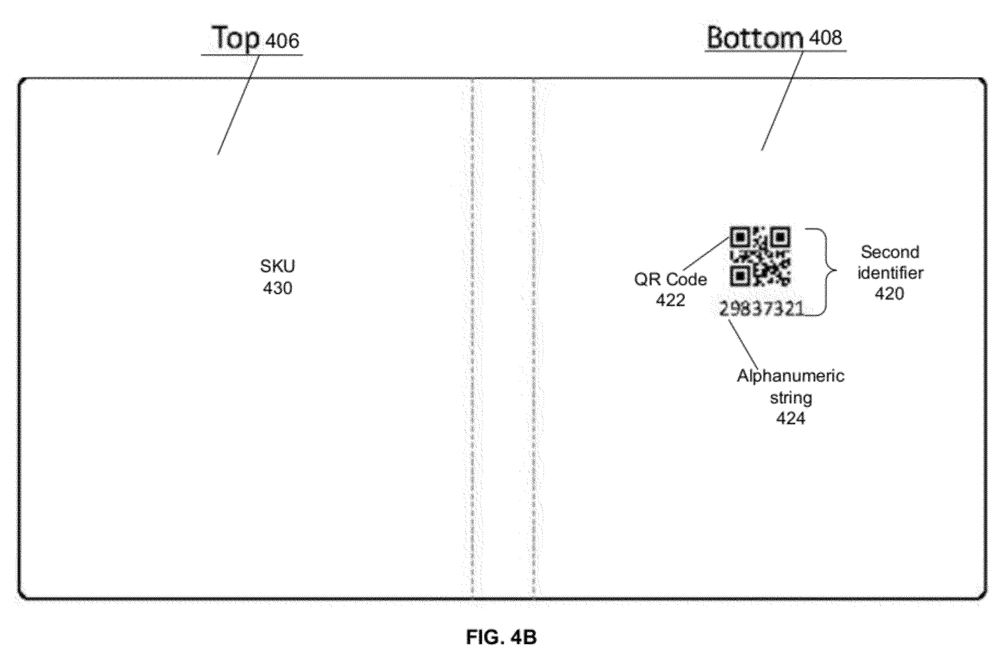

FIGS. 4a-7b depict various embodiments of a product package bearing a first identifier 410 and a second identifier 420 which may together serve to enable trigger a set of rules conferring one or more benefits upon a consumer. The identifiers 410 and 420 may be presented on substrate such as an insert, sleeve, cover, casing, article, or packaging having the first identifier 410 on one side and the second identifier 420 on the opposite side. This substrate may be part of the container housing the product itself, such as a cereal box, bag of chips, or television box, or alternatively, the substrate may be inserted or attached to a separate product casing, such as a label, sleeve, jacket, or cover of a CD, DVD, or Blu-Ray disc that is inserted into a case. Alternatively, the identifiers 410 and 420 may be printed or affixed directly upon the product (such as upon a surface material such a metal, plastic, cardboard, or glass) with appropriate positioning in lieu of there being a dedicated insert. Either or both of these identifiers 410 and 420 may include a bar code, a QR code, an alphanumeric string, a uniquely identifiable image, or some combination thereof. As will be explored in further detail with reference to FIGS. 4a-7b, in some embodiments, the substrate or material may be positioned such that a first side is outwardly facing and can be optically read by a human or machine, while the second side is inwardly facing so that it cannot be optically read by a human or machine until the product or its packaging has been opened.

In some embodiments, the insert via the product or its packaging may be enclosed or sealed in such a way (e.g., destructible shrink-wrap, seal, tape, label, etc.) so as to enable a first party (e.g., a retailer) or a second party (for example, a consumer) to readily ascertain that the product or its packaging has been opened and the insert's codes may have been compromised. For example, a substrate attached or inserted into a product container (or upon the actual product surface) may bear the second identifier on a surface that would not be visible while the package is closed. If the substrate is a peel-away label, for example, the label may be selected such that any attempt at replacing it after peeling it away would be noticeable by a consumer. Alternatively, the product casing may have a removable pin or other one-way mechanism which enables access to the second identifier, but which cannot be replaced once removed. A deformable button or pop-out material may also serve as evidence that a product has been tampered with, where such mechanisms do not restore to their factory default state after being actuated. Such mechanisms enable the product to be tamper-evident such that compromised products can be immediately identified, minimizing the risk that they will be purchased by unwitting consumers.

In some embodiments, a product or the product's packaging may allow the second identifier 420 to be read by a consumer once the product or package is opened. For example, the product or its packaging may have cut-outs that allow the second identifier 420 to be seen through them. Alternatively, the product or its packaging may be made of a transparent or partially transparent material that allows the second identifier 420 to be viewed through the transparent. Optionally, this material may be treated or modified to reduce glare that might otherwise impede a reader's ability to read the second identifier when formatted as machine readable code (e.g., a bar code or a QR code). In still another example, the product or its packaging may be unfolded or opened in such a way so as to reveal the second identifier 420. Such examples will be explored in further detail below with reference to FIGS. 4a-7b.

FIG. 4a is a screen capture of the rear 402 and front 404 of exemplary insert bearing a visible first identifier 410 and a second identifier 420 (as shown in FIG. 4B) in accordance with one embodiment of the present invention. As shown by the figure, the first identifier 410 may be oriented such that it is visible to the line-of-sight of reading device such as a bar code scanner. Optionally, an additional code such as an SKU code 430 may also be disposed anywhere upon the visible side of the insert as shown in FIG. 4a.

The SKU code 430 is typically associated to a group of similar products. In some embodiments, the first identifier may be associated with the SKU code 430 and used in the authorization process. A requested right or benefit may be associated to the SKU 430 associated with a movie title which in turn is associated with a population of first identifiers (the DVDs making up the population defined by the SKU 430).

FIG. 4b is a screen capture of the top 406 and bottom 408 of the exemplary insert depicted in FIG. 4a. The second identifier 420 may comprise any combination of machine and/or human readable identifiers. For example, as depicted in FIG. 4b, the second identifier 420 includes QR code 422 and alphanumeric string 424. In some embodiments, the insert may be adapted to fold along the dashed lines (for example, wrapped around a plastic container) in order to conceal the second identifier 420. Optionally, shrink-wrap or a plastic transparent casing may be placed around the container in order to further prevent unauthorized access to the second identifier 420.

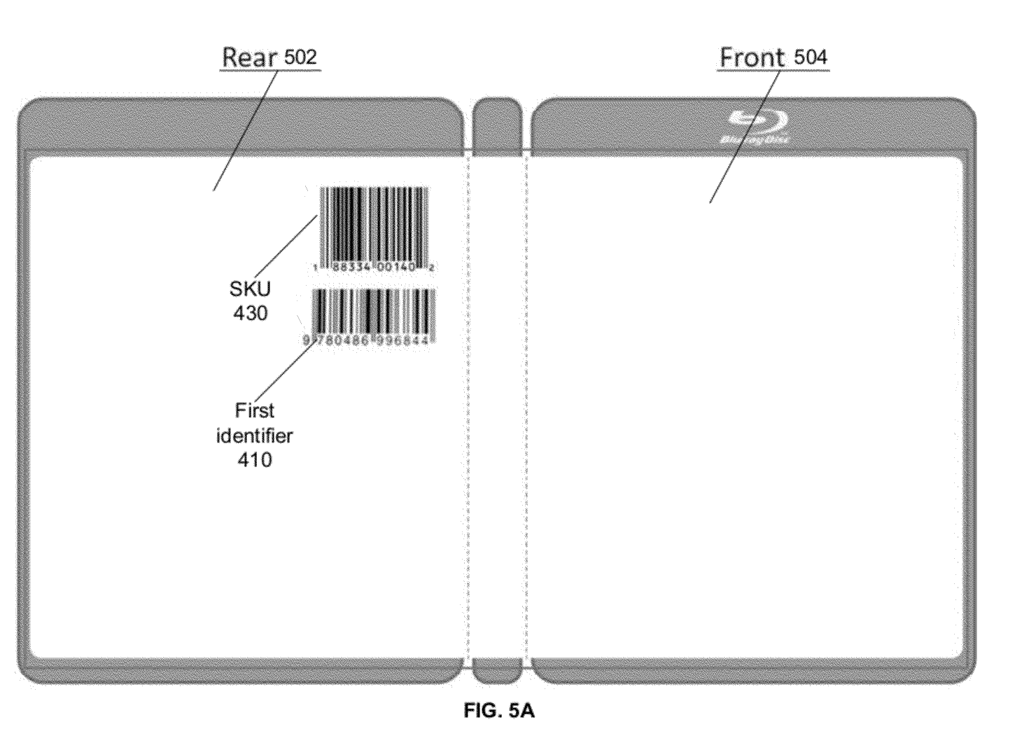

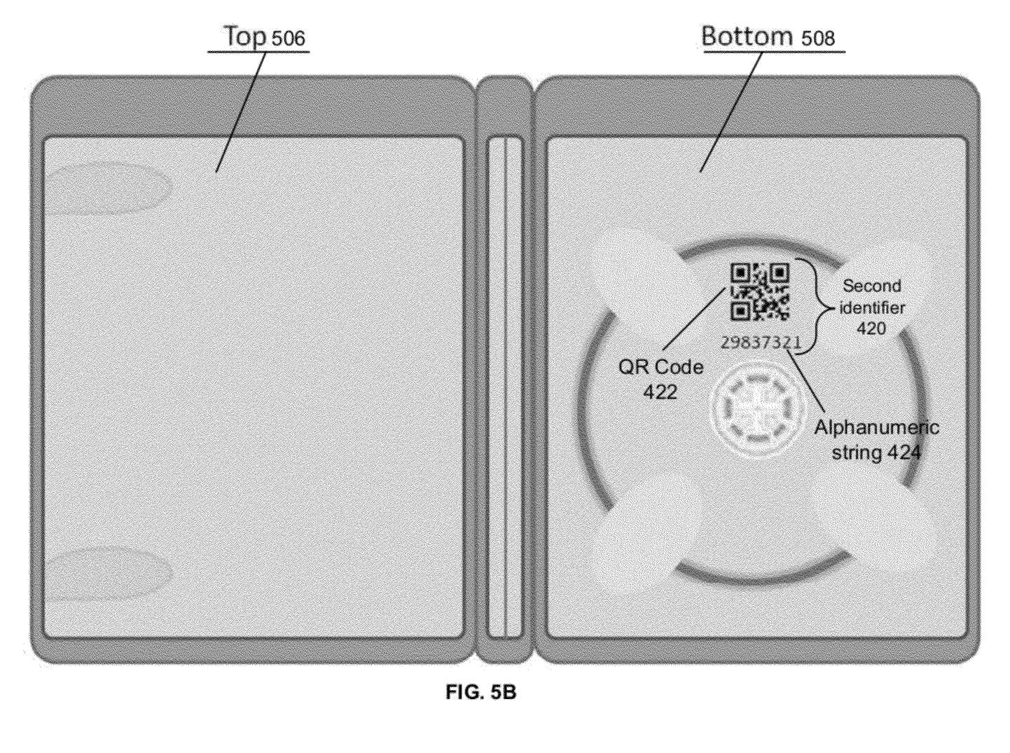

FIG. 5a is a screen capture of the rear 502 and front 504 of exemplary Blu-ray case bearing a visible first identifier 410 and a second identifier 420 (as shown in FIG. 5b) in accordance with one embodiment of the present invention. As in the case of FIG. 4a, the exterior surface may optionally include an SKU code 430 or other identifier in conjunction with the first identifier 410 in accordance with embodiments of the present invention.

FIG. 5b is a screen capture of the top 506 and bottom 508 of the exemplary Blu-ray case depicted in FIG. 5a. As depicted in this example, the insert bearing the second identifier 420 including the QR code 422 and the alphanumeric string 424 may be visible behind a transparent or partially transparent layer disposed within the Blu-ray case. Alternatively, the second identifier 420 may be disposed upon a portion of the Blu-ray casing material itself Also, according to some embodiments, the second identifier 420 may be positioned such that it will be shielded from view by a Blu-ray disc snapped into the disc tray.

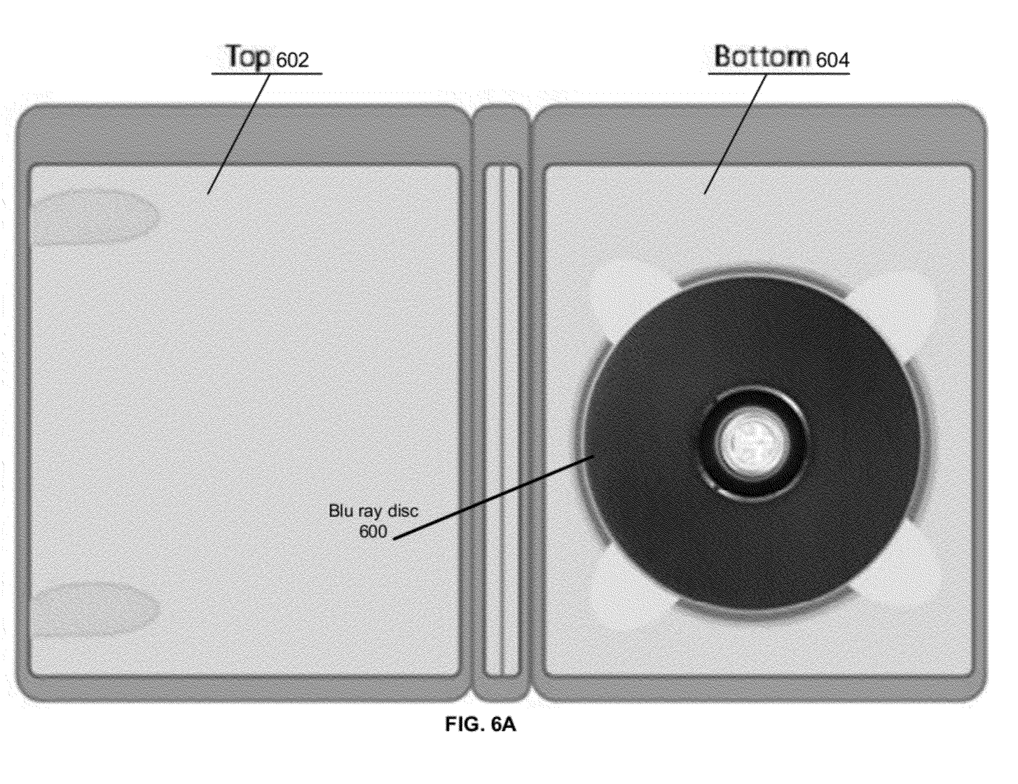

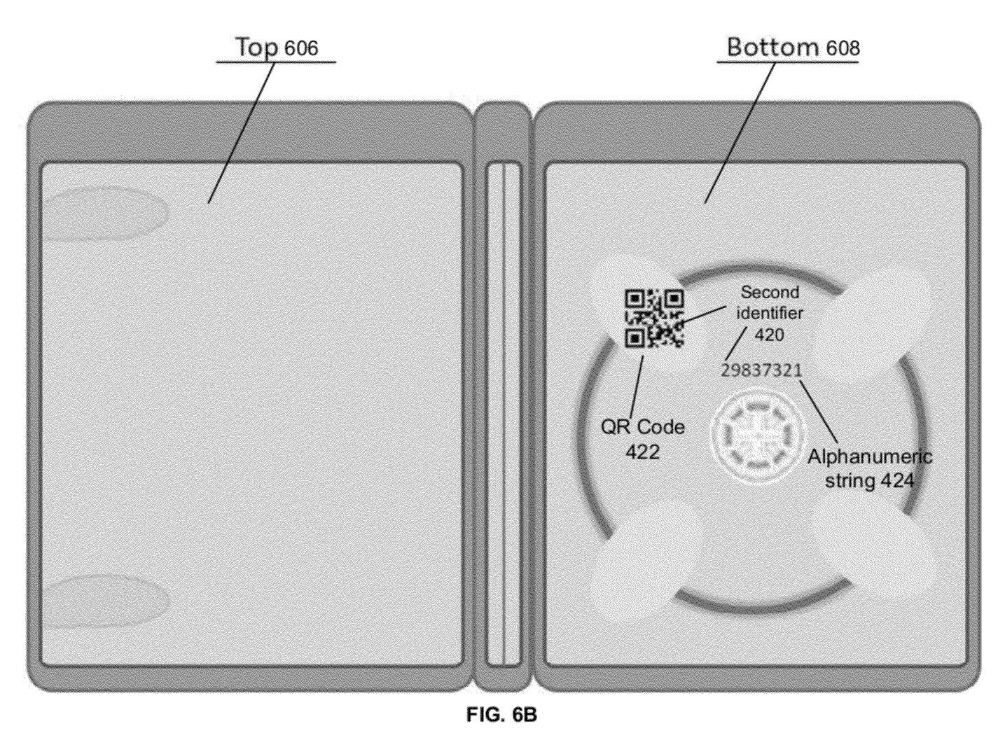

For example, FIG. 6a is a screen capture of the top 602 and bottom 604 of an exemplary Blu-ray case containing an insert with a second identifier hidden by a Blu-ray disc in accordance with one embodiment of the present invention, while FIG. 6b is a screen capture of the top 606 and bottom 608 of an exemplary Blu-ray case depicted in FIG. 6a showing the second identifier 420 exposed when the Blu-ray disc is removed. Note that while the Blu-ray disc 600 itself is depicted as shielding the second identifier from view, myriad types of elements may be used to shield the second identifier in the alternative. This includes, without limitation, removable tabs, stickers, scratch off material, sliders, switch panels, and other similar mechanisms. These mechanisms serve as a further impediment to unauthorized access of the restricted content.

As shown by FIG. 6b, according to some embodiments, all or a portion of the second identifier 420 may be disposed within a recess (used for lifting a disc) for greater transparency and improved readability. This may increase the reliability of the reads taken by automated readers such as scanners or photographic devices. A human readable code may be positioned in a separate disc recess or behind the transparency such as the alphanumeric string 424 depicted in FIG. 6b.

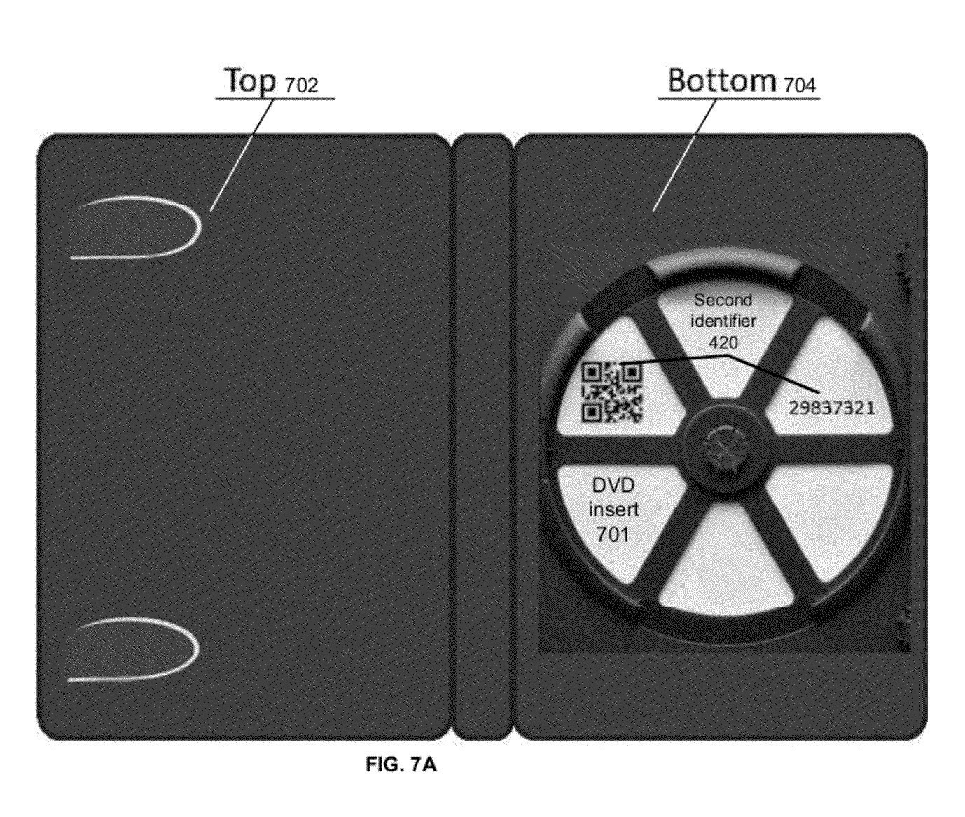

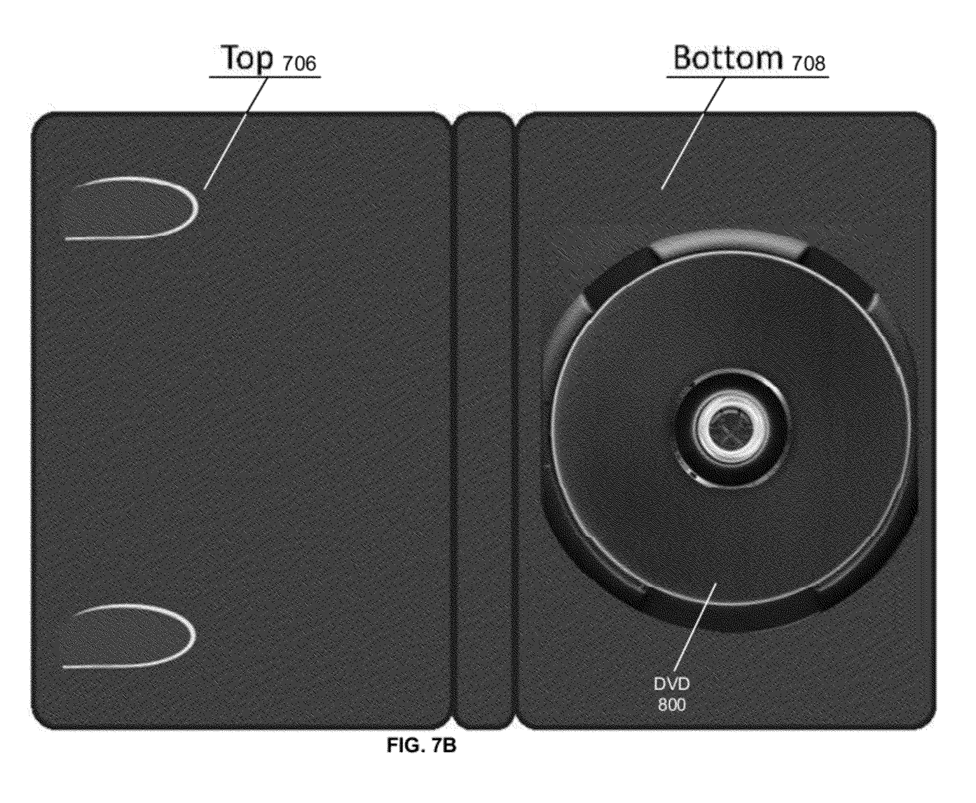

FIG. 7a is a screen capture of the top 702 and bottom 704 of an exemplary digital video disc (DVD) case containing an insert with a second identifier visible through cut-outs in the case in accordance with one embodiment of the present invention, while FIG. 7b is a screen capture of the top 706 and bottom 708 of the exemplary DVD case depicted in FIG. 7a where the second identifier is hidden by a DVD 800. As shown in FIG. 7a, the form of the DVD case may include one or more apertures or cut-outs enabling the second identifier 420 to be visible when the disc is removed. As shown by FIG. 7b, the DVD 800 may serve to block the second identifier 420 when it is snapped into its DVD tray.

According to some embodiments, the first code and the second code may be printed on the same side of the insert. In such cases, the insert may be folded or closed in such a way that the unique code is not externally readable until it is unfolded or opened. To prevent a casual criminal from defeating the system, a means of showing that the product or its package has been prematurely opened can be incorporated into such embodiments.

To further impede criminals from opening products prior to the sale and theft of access codes, it may be advantageous for the second identifier to be covered with an opaque material (e.g., latex) that can be scratched off by the consumer after the item has been purchased. In some embodiments, the second identifier may also be physically accessible (e.g., via the cutout) to the consumer of the restricted content.

Also, according to some embodiments, neither a first party (e.g., a retailer) nor a first unique code is necessary for accessing the content. For example, consider a DVD without the first identifier including external shrink-wrap and/or spine labels (tape). In such a configuration, the right to access secure media content is authorized when the key registry receives the code previously associated with the second identifier. This particular code remains protected from misuse/theft until the product is sold since open packaging (tampered shrink-wrap, spine labels, etc.) would discourage retailers from selling (or consumers from buying) a product that had been tampered with.

In some embodiments, additional code identifiers may be used to unlock protected media content. For example, instead of relying on only a paired set of codes code—a third, fourth, or even an nth code may be used in the alternative. This may be used, for example, to track an item of merchandise across multiple levels of a supply chain.

In some embodiments, multiple codes from separate items may be required before content is unlocked. Loyalty or frequent buyer programs, for example, may require a set number of separate purchases before access to designated content is granted. Content may also be unlocked when multiple actors are involved in a group activity (e.g., multiparty experiences or multiplayer games).

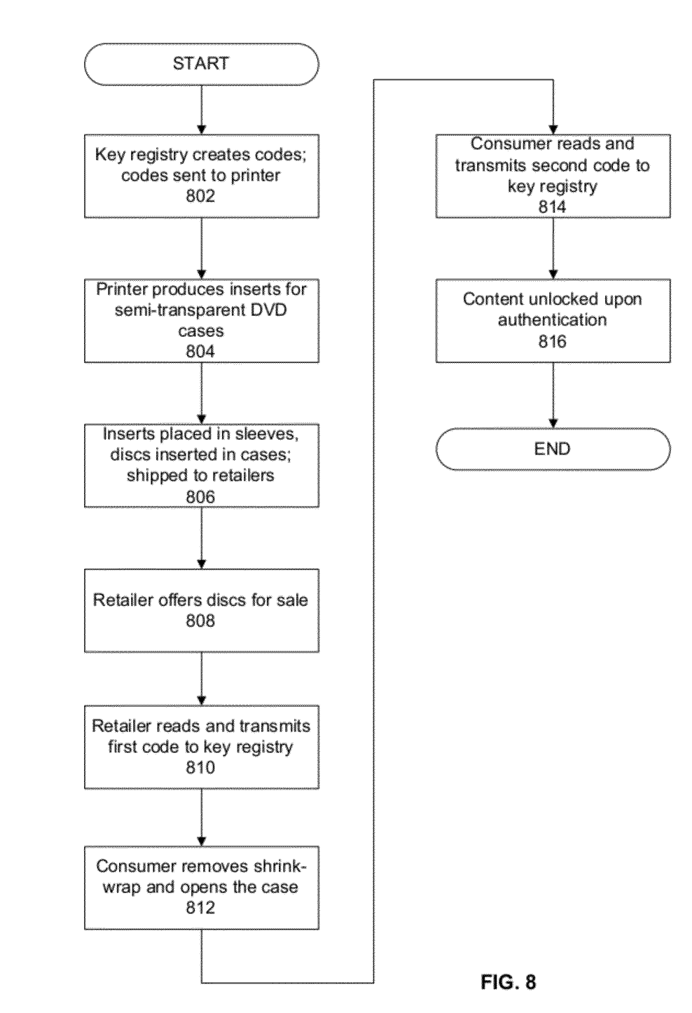

FIG. 8 is a flow diagram illustrating a high-level method of utilizing a system of controlling access to secure media content in accordance with one embodiment of the present invention.

At block 802, the key registry generates, stores, and sends to an insert printer a series of paired identifiers. Rights and rules associated with each code in the key registry may also be generated.

At block 804, an insert printer produces inserts for DVD cases such that the first and second codes are printed on opposite sides of each insert in such a way that the second code will be revealed only when the case has been opened. As mentioned above, the DVD case may include a transparent or semi transparent layer positioned over the back side of the insert such that the second identifier is visible through the transparent or semi-transparent layer.

At block 806, the DVD manufacturer places the inserts into clear plastic sleeves common to the outside of DVD cases. The discs are then inserted into cases, the cases are then closed and subsequently shipped to authorized retailers. At block 808, the various retailers then offer these cases for sale.

When one of the movies is sold, at block 810, the retailer reads and transmits the first code to the key registry. An attempt to authenticate the code is then performed at the authentication node. Optionally, a confirmation message may be presented to the retailer indicating successful or unsuccessful authentication of the first code.

At block 812, the consumer that bought the disc later removes the shrink-wrap and opens the case revealing the second code through the semi-transparent plastic of the case. The consumer then reads and transmits this second code to the key registry at block 814.

Upon successful authentication of the second code, then at block 816, the content is unlocked. The consumer may then be given access to the media content and the process then ends.

Note that while the previous figures (including FIG. 8) depict access to content being granted in a particular combination (the first code is authenticated, followed by the second code), in other embodiments, other combinations are also possible (e.g., the second code followed by the first code). In some embodiments, no particular combination of code authorizations is necessary for unlocking requested content.

As stated above, it some embodiments, in order to avoid mismatching first codes and second codes, a printing solution may be employed where the first code and the second code are printed upon the same article (e.g., duplex printing) and/or printed at approximately the same time. In other embodiments, however, the first code and the second code may be printed in two distinct operations. In such applications, the first printed code may be read immediately prior to the printing of the second code in order to ensure that the two codes are properly matched. Likewise, in embodiments where codes are printed on two separate articles, the first and second codes may be associated at the time one or more of the articles are applied to an item or its packaging.

In some embodiments, a single item may include a first code and a second code on one article (e.g. a bottle cap or peel-back label), and a third code on a separate article (e.g. a sticker or label) affixed to the item.

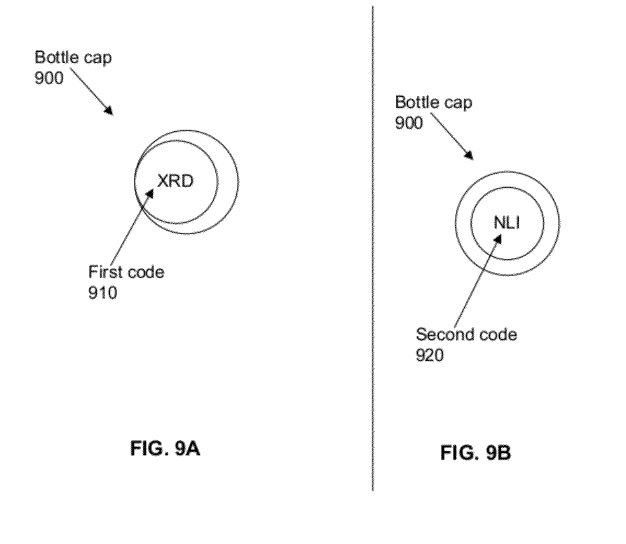

For example, FIG. 9a is a block diagram illustrating the top of an exemplary bottle cap 900 bearing a first 910 and second code 920 according to one embodiment of the present invention, while FIG. 9b is a block diagram illustrating the underside of the bottle cap depicted in FIG. 9a. As illustrated by this figure, the first code 910 and the second code 920 may be printed on an article (e.g., a seal) inserted inside the transparent bottle cap 900, where the first code 910 can be viewed externally through the bottle cap, and the second code 920 can be viewed only when the bottle cap is removed from the bottle. In cases where size of the article is a limitation, the first code may be of a type that is not readable at the point-of-sale by conventional code readers. Therefore, an externally facing third code may be printed on a separate label that is affixed to the item.

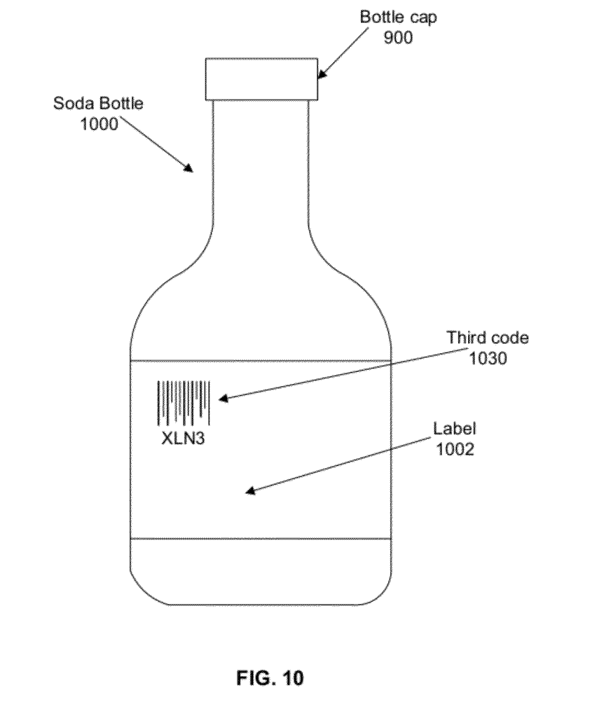

For example, FIG. 10 is a block diagram illustrating a soda bottle 1000 containing a label 1002 bearing an exemplary third code 1030 according to one embodiment of the present invention. The third code 1030 may be a machine-readable code that is printed or affixed to the label 1002 as illustrated by the figure. In some embodiments, immediately prior to the final packaging step, the first codes 910 affixed to the individual items (e.g. individual soda bottles 1000) are optically read or scanned and associated with the third code 1030 printed on the label 1002.

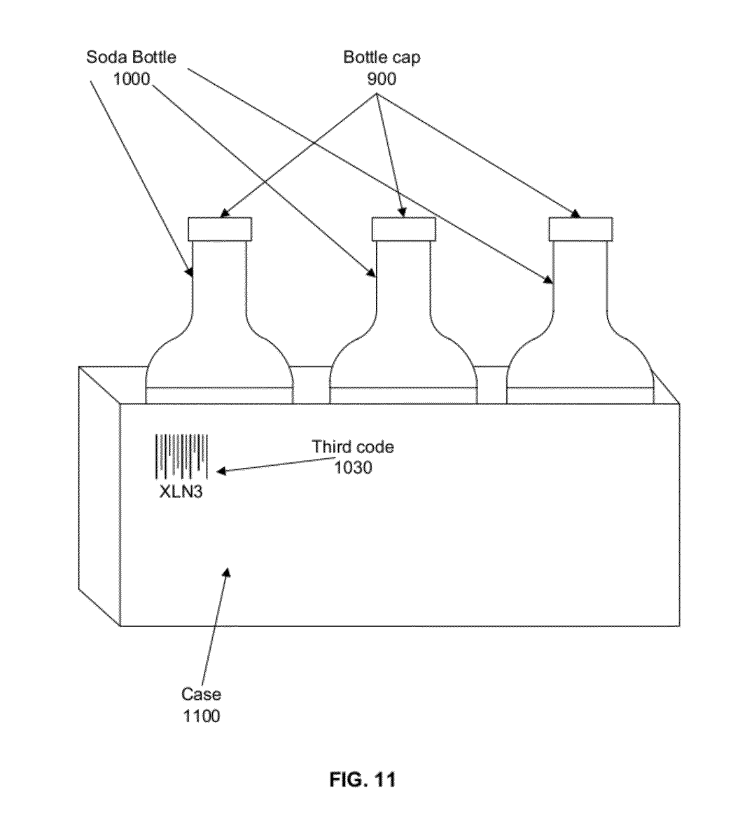

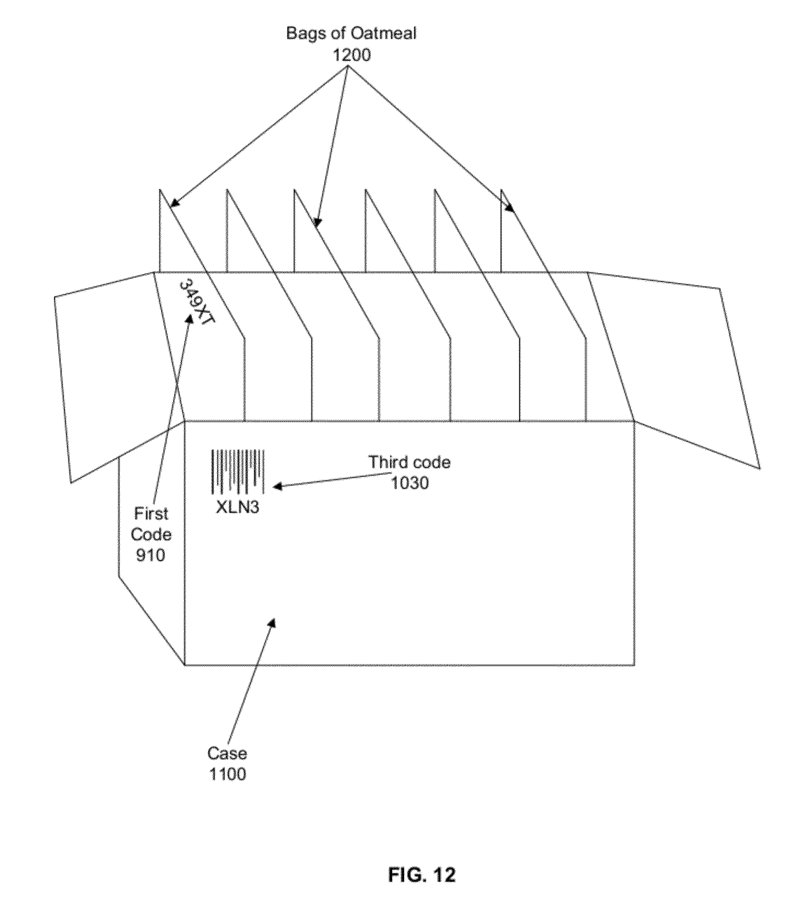

Alternatively, a multitude of items (each with a first code 910 and a second code 920) may be associated with a single externally visible third code 1030 located on an article containing each of the items (for example, upon a product package, bag, holder, or other such container). Examples of this are best illustrated with reference to FIGS. 11 and 12.

FIG. 11 is a sketch of an exemplary soda bottle case bearing a third code according to one embodiment of the present invention. As shown by the figure, the soda bottle case 100 contains a plurality of soda bottles 1000 each topped with a respective bottle cap 900. The first code and second codes (not shown) may be printed on an article inserted inside each transparent bottle cap where the first code can be viewed externally through the bottle cap, and the second code read only when the bottle cap has been removed (as in the manner previously discussed with respect to FIGS. 9a and 9b). For a multi-pack of bottles 1000 each first code may be associated with a single third code 1030 printed on the package or case 1100 containing the items. This may be used at the retail point-of-sale to identify the particular item and/or authorize the second codes (not shown). In some embodiments, the association of the first codes with the third code may be performed during the packaging process in order to avoid mismatching (i.e., when the items/bottles to be contained within a specific article are known with a high degree of certainty). This may involve, for instance, reading the first code of each item immediately before such an item is inserted, wrapped or otherwise contained within the package or product case 1100.

FIG. 12 is a sketch of an exemplary oatmeal case 1100 bearing a third code 1030 according to one embodiment of the present invention. As depicted in this figure, a first code 910 and a second code 920 (not shown) may be printed on opposing sides of a material used to form individual packages (e.g. bags of potato chips or packets of oatmeal) of products that will in turn be packaged in a larger package (e g a box or bag of individual packages). After the individual packages have been assembled and filled with product (e.g. potato chips or oatmeal), the first code 910 is externally viewable while the second code 920 may only be read when the individual items (e.g., bags of oatmeal 1200) are opened. For a multi-pack of individual items, each first code 910 may be associated with a single third code 1030 printed on the package or case 1100 containing the items. This may be used, for example, at the retail point-of-sale to identify the item and/or authorize the second codes 920 located within each individual item. In some embodiments, the association of the first codes 910 with the third code 930 may be performed during the assembly process in order to avoid mismatching (i.e., when the items/bags 1200 to be contained within a specific article are known with a high degree of certainty). As before, this may involve, for example, reading the first code 910 of each item immediately before such an item is inserted, wrapped or otherwise contained within the package or product case 1100.

Note that in the preceding examples, the third code 1030 may be preprinted or printed at the time the individual items are contained within the package. It should also be noted that while printing may be used to apply codes to various items and articles, numerous other methods are possible within the scope disclosed here. These methods include (but are not limited to) etching, engraving, and molding processes.

In cases where the consumer may be confused as to whether they should use the first code 910, the second code 920, or the third code 1030 in order to access their benefit, in some embodiments, the first codes 910 may be altered so that they are no longer readable or recognizable after they have been associated with the third code 1030. Various means may be employed for altering such codes and/or the package used to contain them, and the alteration could take place before or after the items are contained within the Package. In some embodiments, the alteration not only makes the first codes 910 unreadable, but is sufficient to remove the perception that such codes should even be read. In other embodiments, the first code may be specifically selected to be of a type that is not accessible by the consumer.

In some applications it may also advantageous for a multitude of second codes 920 to be affixed to separate items associated with a single third code 1030 without the use of first codes 910. In some embodiments, the third code 1030 is externally visible and configured on a package that contains the individual items and prevents the second codes 920 from being read until opened or removed. For example, the second codes may be printed on the surface of cans of soda or beer, and associated with a single third code 1030 printed on the packaging that holds a ‘six pack’ of cans. The third code 1030 may be used at the point-of-sale to authorize the second codes 920 which are hidden until the Package is removed by the consumer.

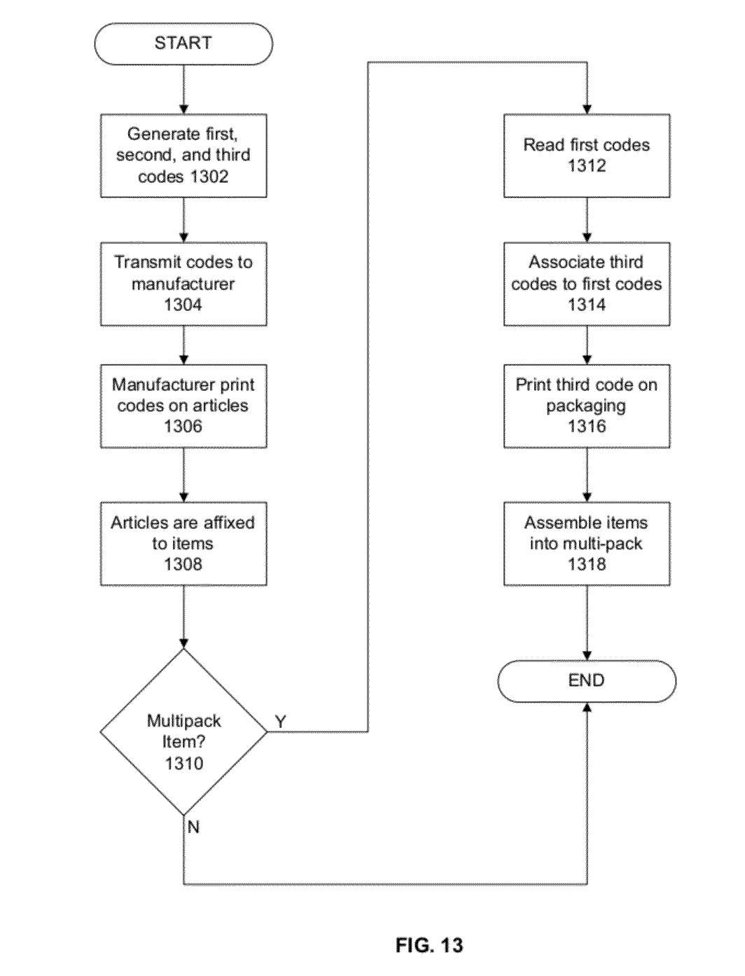

FIG. 13 is a flow diagram of an exemplary process of packaging codes as may be utilized by a manufacturer according to one embodiment of the present invention. As depicted in this figure, at block 1302, the first, second, and third codes are generated (for example, at key registry 212 depicted in FIG. 2). The codes may then be transmitted to the manufacturer at block 1304.

Next, at block 1306, the manufacturer may print the codes on either a surface of the item, a package containing the item, or on an article that is to be affixed to the item or its packaging. In some embodiments, duplex printing may be used to apply the first 910 and second 920 codes simultaneously or near-simultaneously in order to minimize errors in matching. The articles may then be affixed to the items at block 1308. At decision block 1310, in the event that the items are to be sold individually, the process then ends.

On the other hand, if the items are sold together, for example, as bundled in a multi-pack, a plurality of first codes may be read at block 1312 and associated with a third code at block 1314. The third code may then be printed on the packaging or an article to be affixed to the packaging at block 1316, and the items assembled into a multi-pack at block 1318.

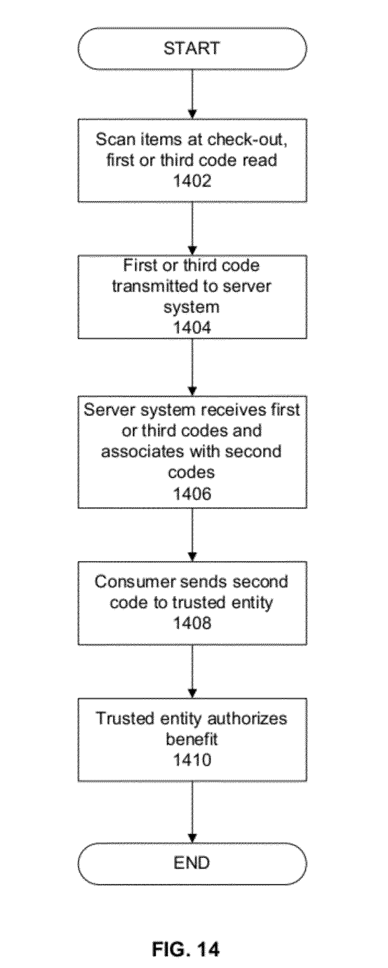

FIG. 14 is a flow diagram of an exemplary process of processing codes as may be utilized by a manufacturer according to one embodiment of the present invention. At block 1402, items are read by a machine reader (for example, as read by a code scanner at a check-out), during which time the first code 910 or third code 1030 may be read.

The read code may then be transmitted to a server system at block 1404. In some embodiments, the server system may be an authentication node 100 (e.g., as depicted in FIG. 1). Once the read code has been successfully received, the server system may then associate the code with a second code at block 1406. When the consumer sends the second code to the trusted entity at block 1408, the trusted entity may then authorize the benefit at block 1410, and the process then ends.

In cases where the consumer might be confused as to which code is used to access a benefit (i.e., the code on the package or the code on an item contained by the Package), the third code may be altered so that it is no longer readable after being read at the point-of-sale.

As previously depicted in FIGS. 9a, 9b, and 10, in some embodiments, the first 910 and second codes 920 may be incorporated into a bottle cap 900 (for example, as commonly used for soda or water) in several ways. The cap 900 may be made from a transparent or semi-transparent material with sufficient clarity such that a first code 900 can be viewed through the top of the cap 900. The first 910 and second 920 associated codes may be duplex printed on a seal which is inserted into the cap so that the first code 910 is visible when the cap 900 is on the bottle 1000 (see FIG. 10), and the second code 920 is on the inside of the cap 900, and only visible when the cap 900 has been removed. In this case, the cap 900 may be manufactured without molding artifacts that might interfere with a clear view of the code through the cap material. In some embodiments, where semi-transparent material for the cap 900 is used, the seal surface with the first code 900 must be in close contact with the cap material to permit sufficient contrast and resolution for reading the code through the material. In some embodiments, the first code 900 may be printed on the outer top surface of a semi-transparent or opaque cap and the associated second code 920 is printed on the inside of the bottle cap. Similarly, the first code 910 will be externally visible, while the second code 920 is only visible when the cap is removed.

In some embodiments, the seal may be affixed to the rim of the bottle 1000 rather than inside the cap 900. The first 910 and second codes 920 may be duplex printed on opposite sides of the seal prior to applying the seal to the bottle. In some embodiments, the cap may be sufficiently transparent to allow reading the first code 910 through the cap 1000. The second code 920 becomes available and readable only after the cap 1000 and seal are removed by the consumer. Alternatively, the first code 910 may be printed on the external surface of the cap 900 and the associated second code 920 may be printed on the top surface of the seal, where the cap material is sufficiently opaque to prevent reading the second code 920 through the cap 900. The first code 910 may be visible and readable at the point of sale, while the second code 920 is accessible and readable only after the consumer has removed the cap.

Bottle caps 900 typically have a tamper-evident nature, such as a plastic ring that breaks off when the cap is unscrewed. This provides evidence to store employees and consumers that the second code 920 (i.e., the one used to access a benefit) may have been compromised and hence, the ability to access the Benefit may have been compromised as well. Some bottle caps 900 however do not have a tamper-evident feature and rely on a seal on the rim of the bottle separate from the cap 900. If the seal has been even partially separated from the bottle 1000, this serves as evidence that tampering may have occurred. Preferably, the first code 910 becomes unreadable if the cap has been loosened or removed (i.e., if someone has opened the bottle 1000 to view the second code 920.)

For carbonated beverages, the first code 910 or an indicator may be made out of a pH sensitive material (pH indicator) (e.g., as referenced in published U.S. patent application 20100196636). Since carbonation and moisture in the container will keep the pH acidic, the first code 910 is readable. However, if the bottle 1000 is tampered with, carbonation levels will drop due to introduction of air, and the code would fade. In some embodiments, the materials used for packaging of food products must possess “food safe” properties or otherwise be protected with sufficient encapsulation so that these do not come in contact with food products or leach into them. Such food products may also be encapsulated within polymer membranes or polymeric capsules (microencapsulated in a size which is typically about or smaller than 20 μm and a preferred range is between 5 to 10 μm), so that the polymeric capsule skins are permeable to gasses and water, while preventing the diffusion of the indicator from going outside. Such capsules can then be mixed with other ingredients to yield printable inks

In cases where duplex printing is conducted on a medium so that one of the first code 910 or an indicator is visible through a transparent cap or film, and the second code 920 is visible only when the product is opened, the medium may be optically opaque, but possess specific permeability properties to the gases contained in the product and or those present in the ambient atmosphere to effect this change. For the above carbonated beverage example, the medium may have good barrier properties to liquids or large organic molecules including the indicator, but poor barrier properties to gases, particularly to carbon dioxide, water vapor and air, so that in the closed package carbon dioxide and the water vapor are able to permeate the atmosphere around the indicator to keep it in one colored state. Once the product is opened air may penetrate the package resulting in an increase in pH changing the indicator color (or the dye color so that it blends with the background to erase the code, or conversely, the background changes color to merge with the code color which also leads to the erasure of the code (see U.S. provisional patent application Ser. No. 61/484,995 filed May 11, 2011 and entitled “Dynamic Optical Codes and the Methods of Making the Same”) for subtractive and additive codes). This change may be irreversible so that even if the package is closed, and the carbonation pressure develops, the original color/code will not be restored. Such changes may be chemical or physical changes.

In all cases, the change may be detected by using materials which optically change by either adding a stimulus or removing one (or both, such as in the case of adding or increasing one stimulus and removing or decreasing another). These stimuli may also be chemical or physical. Examples of chemical stimuli are alcohol, other gas combinations (that the product may give off, e.g. fruits and juices, fragrances, flavanoids, medications), oxygen (e.g., product bags may be filled with inert gas to preserve freshness by reducing oxidation, and then are exposed to oxygen upon opening) and water, etc. Physical stimuli include temperature, pressure (force or strain including volume change), radiation exposure (including optical (UV, deep UV, and IR), y-rays, x-rays). Many technologies that use similar principles are extensively developed for expiration indication of products (e.g., see published U.S. patent applications 20050286350 20050037498 and 20030235119).

As discussed above, in order to change the second code 920, the stimulation used should be such so that this energy or stimulation can be transmitted through the media onto the surface where this ink or material forming the second code 920 is deposed. The type of materials and simulation used may be product and environment dependent (e.g., in a manufacturing environment where the second code 920 is obliterated or changed through a closed system, such as a capped bottle 1000). This may be different then the one used at the point-of-sale. If a cap 900 or a packaging is used through which the second code 920 is read, then in order to reach that with the stimuli, one may need to ensure that this packaging is largely transparent to the stimulus and also the packaging properties are not altered in a way so that it would destroy its functionality.

As a specific example, caps 900 may be used of materials that are transparent to the radiation being utilized for the stimulation. As most common packaging plastics for consumer goods do not transmit uniformly in deep UV (UV below 290 nm), one may use specific UV bands tailored to a particular plastic, or use gamma(γ) radiation for this purpose. Use of UV or γ-radiation may not be preferred in point-of-sale systems due to operator/customer safety considerations, but is acceptable in manufacturing environment. Siltech Ltd. (in Nottingham, United Kingdom), makes Sterisure Gamma labels that change color when exposed to gamma radiation, such labels and active materials in these may be used for this purpose. Similarly, Silmark product from the same company responds to optical radiation (including UV, visible and IR). One may need to ensure that the plastic used for packaging is largely transparent to the desired optical radiation. The IR system at low energies with low power would be suitable for both manufacturing and the point-of-sale environments. As described in published U.S. patent application 20100018957, typical industrial lasers such as, CO₂, Nd-YAG, UV and light emitting diode lasers may be used. The pigments that are susceptible to these are based on transition metal oxides.

For a manufacturing environment, where the first code 910 becomes unreadable after the product has been packed in a multipack unit, one may opt to use another strategy. The first code 910 may also be printed out of a material such that this material or the background changes color with time and they blend together so that these are not readable anymore. This time should be greater than the time required in the manufacturing, but less than when this has to be made unreadable, e.g., time until it is transported to the point of sale. As an example, this code may be only visible for the first few hours after it has been printed. This erasure may be caused by the various stimulants discussed above, some of these are exposure to oxygen, temperature, ambient light, something in the product, e.g., vapors, water, carbon dioxide, ethanol, etc. One may also add additives, e.g., oxidants and reducing agents in the ink composition, that would result in a reaction causing these prints to fade/change color with time, e.g., also see U.S. Pat. No. 7,742,367. A preferred class of materials is one with materials that will phase out or blend into the background colors by gradual oxidation. This oxidation process can be controlled by inherently tuning the ink materials and/or by covering these with coatings and films of appropriate polymeric materials with controlled oxygen transmission. As a specific example, intrinsically conductive polymers such as polyaniline, polthiophene, polypyrroles, etc., change their optical properties (e.g., color) when these go from one state of oxidation to next. These can be formulated as inks in solutions and reducing agents added to them (e.g., ascorbic acid). Depending on the concentration of ascorbic acid and the conductive polymer, the inks when deposited and subjected to ambient air will gradually oxidize and change color. Those combinations are preferred which are colored in the reduced state, or the color in the oxidized state is matched to the label background so that upon oxidation the colors blend and the printed matter is not discernable. For example PEDOT solutions are sold as Clevios™ (by Heraeus located in Hanau, Germany). This material is a blend of poly(3,4-ethylenedioxy-thiophene) and polystyrene sulfonate (PEDT/PSS). Such materials may be mixed with reducing agents so that they are deposited in intensely colored state. With time, the printed material oxidizes and becomes almost colorless. To tailor their color fading by oxidation prints of these materials may be coated with polymers. Depending on the permeability and thickness of the polymeric coatings one can exercise additional oxidation control. Some of the polymers such as copolymers of vinyl alcohol and nylons will change their oxygen permeability depending on the relative humidity. Table 1 shows the large extent of oxygen permeation properties which can be achieved by selecting appropriate polymers. Many transition metal oxides such as tungsten oxide are deeply colored when reduced and colorless when oxidized. Inks based on such materials when mixed with reducing agents may also be used.

TABLE 1

| | Oxygen |
|---|---|
| | permeability |
| | (cm³-μm/ |
| Polymer | (m²-day-atm)) |
| Polyvinylidene chloride (Saran ™ MA) | 22 |
| Ethyl vinyl AlcohoPoly e (EVOH-38) | 38 |
| Nylon 6 | 678 |
| Polyethylene terephthalate* | 1,600 |
| Polypropylene* | 59,000 |
| High density polyethylene* | 59,000 |

*At 23° C., 75% RH, others at 20° C., 80% RH

In yet another embodiment (for example, a manufacturing environment), one may print second code 920 using a photochromic or a thermochromic ink so that the printed pattern is not visible under ambient conditions. This can only be activated under intense light (intensity or specific wavelength) or at a high temperature which is generally not encountered in ambient conditions. During manufacturing, just before packaging or reading of this label, it may be subjected to these conditions so that the print is visible. The print may be read after this exposure before it fades away. One can tune bleach times after the exposure by appropriately selecting materials so that it lasts for sufficient time to allow reading. In yet another alternative, the inks used are luminescent (fluorescent or phosphorescent) or change color (e.g., see photochromic and luminescent inks from HW Sands Inc, Jupiter, Fla.), and optionally activated by wavelengths not found in ambient (e.g., UV less than 290 nm, γ-rays). Once such labels are exposed to these conditions, the print can be read. If luminescent inks are used, the print may be read in the dark. As discussed earlier, these inks may be encapsulated in order to avoid direct contact with food or to touch, and these may also be printed on the outside of the package to avoid the food contact completely.

In some embodiments, the first 910 and second codes 920 may be applied to canned beverages, e.g. soda, energy drinks, etc. The first code 910 may be printed on the surface of the can and the second code 920 is printed on a part of the surface of the can that is completely or partially obscured by an article or feature of the can which is moved or removed by the consumer after the can is purchased and thereby revealing (no longer obscuring) the second code 920. A removable feature may alternatively be a label or sticker. The second code 920 may be hidden under a scratch-off layer. A moveable feature for may comprise a pull tab.

Specifically in the case of a pull tab used to obscure a second code 920 printed on the top of a can, the can and/or the pull tab may preferably be configured in such a way that they prevent the pull tab from freely rotating thus preventing the second code 920 from being viewable/readable unless the pull tab lifted and the can opened. The extrusion in the lid of the can for example used to attach the pull tab may be formed in an oval, rectangular or other shape such that a pull tab appropriately configured to fit the extrusion prevents the tab from rotating. The pull tab may be placed into an appropriately configured recess in the top of the cap 900 to prevent it from rotating. The pull tab may be adhered (glued), tack or spot welded to the top of the can to prevent it from rotating. Additionally, the pull tab may be configured such that abuts the edge of the top of the can in such a way that it will not allow the pull tab to rotate until it is lifted high enough to clear the lip of the can and thus open the can or otherwise indicate by its position that it has been moved and the second code 920 revealed.

The first 910 and second codes 920 may be complementary or additive in nature. Also, the first code 910 may be read while the second code 920 is hidden or unreadable. When the second code 920 is revealed it may be combined with the first code 910 to form a single readable code.

Multi-packs of items, such as soda or bottled water, necessitate using a third code 1030 which can be associated with the individual items within the pack. Typically the codes for the individual items are not conveniently accessible by a code reader, and it would not be convenient to read the first codes 910 of the individual items at the point-of-sale. To address this case, codes from the individual items may be associated with a third code 1030 that is applied to the enclosure or packaging of the items contained within. In some embodiments, at a point-of-sale, only the third code 1030 is necessarily read and through the association with its related first codes 910, the individual items are identified and subsequently their associated second codes 920 also identified and the benefits authorized.

In order to avoid confusion or uncertainty of the consumer over which code is the correct code to scan, the first code 910 may become unreadable, invisible, or otherwise marked as the wrong code to use for redeeming a benefit. The first code 910 may be covered with a label or sticker. This is done as a step on the packaging line or subsequent to the packaging process and after the first codes 910 have been read and associated with the third code 1030.

Individual items may also utilize a third code 1030. A first code 910 may be printed on an item or on its label, and a second code 920 printed on a removable part of the item, e.g. a bottle cap 900, cork etc, and where the second code 920 is hidden until the removable part is removed. A third code 1030 may be printed on the packaging containing the item. The third code 1030 is associated with the item's first code 910 at the time the item is packaged. Through the association of the second code 920 to the first code 910, the second code 920 is thereby associated also with the third code 1030. The third code 1030 is read at the point-of-sale, and the benefit is subsequently authorized by way of its association with the second code 920.

At the point-of-sale, and after reading the first code 910 of an individual item, or the third code 1030 of a packaged individual item, it may be desirable to render the first code 910 unreadable in order to avoid confusion or uncertainty of the consumer over which Code is the correct code to scan. It is desirable that the first code 910 become unreadable, invisible, covered with a label or sticker, or otherwise altered to indicate that it is the wrong code to use for redeeming a benefit. Means for accomplishing this, such as by using chromic materials and additional printing, are described in later paragraphs. Technologies discussed earlier may be used to accomplish this.

It may also be desirable to associate second codes 920 (i.e. hidden codes) directly with third codes 1030 printed on a package containing a multitude of items having individual second codes 920. The second codes 920 may be hidden until the item is opened, such as with a bottle cap 900, or the second codes 920 may be obscured by the items' packaging. At the point-of-sale the third code 1030 is read, and the second codes 920 may be directly associated with the third code 1030 so that the benefit may be authorized for each item.

In some embodiments, a system may comprise a database server and one or more databases which at a minimum store the associations among the first 910, second 920 and third codes 1030. The codes may be generated and maintained on one or more servers in one or more secure environments by a trusted entity. Code associations (pairs and triads) may be formed by the generation of random code values or may be algorithmic with one or multiple keys. Codes may be communicated to and from manufacturers, retailers and the servers securely via the internet by means known in the art.

In a preferred manner code associations are transmitted to a manufacturer of an item or article onto which codes are to be printed, for example a label or a seal insert for a bottle cap 900. The First and second codes 920 are paired and printed in a manner that assures a correct pairing on a given article, such as can be done using a duplex printing process. In the event that a third code 1030 is utilized as with a multi-pack, the first codes 910 are read as they are assembled into the final package, and the third code 1030 is printed on the package. The newly associated values of the first 910 and third codes 1030 are transmitted to the server and stored in the code database. The process can be similar irrespective of whether or not a first code 910 as actually used, i.e. the second code 920 may be read from the items prior to being placed inside the package, and the third code 1030 associated directly with the second codes 920.

Alternatively, a means may be given to the manufacturer to generate code pairs “on the fly”—for instance, by generating a third code 1030 after reading the first 910 and/or second codes 920 from items assembled into a multi-pack. These third codes 1030 and their associated first 910 and/or second codes 920 are then transmitted to the server system and database.

At the point-of-sale, the first 910 or third codes 1030 are read by the point-of-sale reader and transmitted to the database server system. The server system receives and recognizes that code data coming from an authorized site and sales transaction. The point-of-sale system may further if capable render the first codes 910 unreadable. Upon subsequent receipt of the second codes 920 from the consumer, the server system may then authorize and provide the benefits.

While various embodiments of the present invention have been described above, it should be understood that they have been presented by way of example only, and not of limitation. The breadth and scope of the present invention should not be limited by any of the above-described exemplary embodiments. Where this document refers to technologies that would be apparent or known to one of ordinary skill in the art, such technologies encompass those apparent or known to the skilled artisan now or at any time in the future. In addition, the invention is not restricted to the illustrated example architectures or configurations, but the desired features can be implemented using a variety of alternative architectures and configurations. As will become apparent to one of ordinary skill in the art after reading this document, the illustrated embodiments and their various alternatives can be implemented without confinement to the illustrated example. One of ordinary skill in the art would also understand how alternative functional, logical or physical partitioning and configurations could be utilized to implement the desired features of the present invention.

Furthermore, although items, elements or components of the invention may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A substrate containing identifiers used for securing access to a benefit included with the sale of a product, the substrate comprising:
a first identifier disposed upon a first surface of the substrate; and
a second identifier disposed upon a second surface of the substrate, the first and second identifiers being duplex printed on the substrate and configured to form a unique identifier which maps to a set of one or more rules at a remote computing device;
wherein the substrate is configured to be disposed within a container associated with the product such that the second identifier is visible only when the container has been opened.

2. The substrate of claim 1, wherein the substrate is further configured to be disposed within the container such that first identifier is visible when the container has been unopened.

3. The substrate of claim 1, wherein the substrate is an insert.

4. The substrate of claim 1, wherein the substrate is a cover.

5. The substrate of claim 1, wherein the substrate is a surface of the container.

6. The substrate of claim 1, wherein the second surface of the substrate is further configured to be positioned behind a cut-out associated with a first material, and the second identifier is visible through said cut-out.

7. The substrate of claim 1, wherein the second surface of the substrate is configured to be positioned behind a non-opaque material, and the second identifier is visible through said non-opaque material.

8. The substrate of claim 1, wherein the substrate is further configured to fold along a first axis so that a first portion of the substrate hides the second identifier.

9. The substrate of claim 1, wherein the substrate is configured to be disposed within a tamper-evident container.

10. The substrate of claim 1, wherein the container is configured to be encased in destructible shrink-wrap, and wherein the second identifier is visible only when the shrink-wrap has been destroyed.

11. The substrate of claim 1, wherein the container is configured to contain a seal, and wherein the second identifier is visible only after breaking the seal and opening the container.

12. The substrate of claim 1, wherein the product further comprises a removable element, and wherein the second identifier is visible only when the removable element has been removed.

13. The substrate of claim 1, wherein the substrate is further configured to be inserted into the container such that the second identifier is positioned behind glare-resistant material.

14. A material bearing identifiers used for securing access to a benefit included with the sale of a product, the material comprising:
a first identifier disposed upon a first surface of the material; and
a second identifier disposed upon a second surface of the material, the first and second identifiers being duplex printed on the material and configured to form a unique identifier which maps to a set of one or more rules at a remote computing device;
wherein the material is configured to form at least a portion of the product and is positioned such that the second identifier is visible only when the product has been opened.

15. The material of claim 14, wherein at least one of the first identifier and the second identifier comprise a bar code.

16. The material of claim 14, wherein at least one of the first identifier and the second identifier comprise a quick response code.

17. The material of claim 14, wherein at least one of the first identifier and the second identifier comprise an alphanumeric string.

18. The material of claim 14, wherein at least one of the first identifier and the second identifier comprise a uniquely identifiable image.

19. The material of claim 14, wherein the second identifier is disposed underneath a scratch-off material.

20. The material of claim 14, wherein the material is further configured to be encased in destructible shrink wrap, and wherein the second identifier is visible only when the shrink-wrap has been destroyed.

21. The material of claim 14, wherein the first surface of the material further comprises a stock-keeping unit code.

22. The material of claim 14, wherein the material is a tamper-evident material.

23. The material of claim 14, wherein the product is further configured to contain a seal, wherein the second identifier is visible only after removing the seal.
